(19) United States
(12) Patent Application Publication
(10) Pub. No.: US 2008/0317409 A1
(43) Pub. Date: Dec. 25, 2008

(54) Sealed Tube Coupling for Optical Fiber Tubes

(76) Inventors: Rosamund Carol Neat, Hertfordshire (GB); John Kerry, Ipswich (GB); Matthew John Kerry, Ipswich (GB); Jeremy Norman Hardie-Clay, Chester (GB)

Correspondence Address: Sue Z. Shaper, 1800 West Loop South, Suite 1450, Houston, TX, 77027, US

(21) Appl. No.: 11/884,080

(22) PCT Filed: Feb. 8, 2006
(86) PCT No.: PCT/GB06/00436

§ 371 Date: Feb. 8, 2008

(30) Foreign Application Priority Data
Feb. 10, 2005 (GB) 0502676.0

(51) Int. Cl. G02B 6/26

(52) U.S. Cl. 385/43; 385/50

(57) ABSTRACT

A coupling for conduit tubes (16, 16′) for carrying optical fibres or optical fibre units, comprising a body which has two entries (18, 18′), both entries having associated therewith means (20, 20′) to secure the body to conduit tubes inserted into the entries, the body being further provided with a space or chamber (42) between the entries through which one or more optical fibres or optical fibre units may pass, the body having a third entry (34) arranged to enable insertion of sealing material into the space, and means, such as deformable seals (26, 26′), to maintain the sealing material within the space.

This invention relates to tube couplings, and specifically to gas blocking tube couplings for tubes for carrying optical fibres.

Optical fibres are used in the communications industry for transmitting information by light through the individual fibres. The optical fibres are normally housed in a tube, and may be installed after the installation of the tube. One method of installation of optical fibres into tubes is by the blown fibre technique, in which optical fibres are blown along lengths of tube. One or more optical fibres may be packaged into a single fibre unit, e.g. a microduct fibre unit, which may be desirable depending on application.

It is often necessary to block the gas path of a tube containing optical fibres or fibre units, i.e. to prevent gas leaking through the optical fibre/fibre unit interstices. For example, when a communications service line, e.g. a cable, enters a building, it must be ensured that gases cannot pass along the line from the external tube to the internal tube. If the service line passes alongside a gas main, even a small leakage of gas into the service line could be dangerous if left to accumulate in an enclosed space at the end of the service line, such as a device enclosed in housing or casing.

If a tube contains only a single optical fibre or a single fibre unit, a proprietary item with integral sealing can be used for gas blocking of the tube. For example, one such connector has an adjustable seal that can be tightened around the optical fibre or fibre unit within the tube to block the gas path. A second seal ensures a gas block around the outer wall of the tube.

However, this type of gas blocking is not suitable for tubes containing multiple optical fibres or multiple fibre units, as the fibre/unit interstices provide a potential gas leak path.

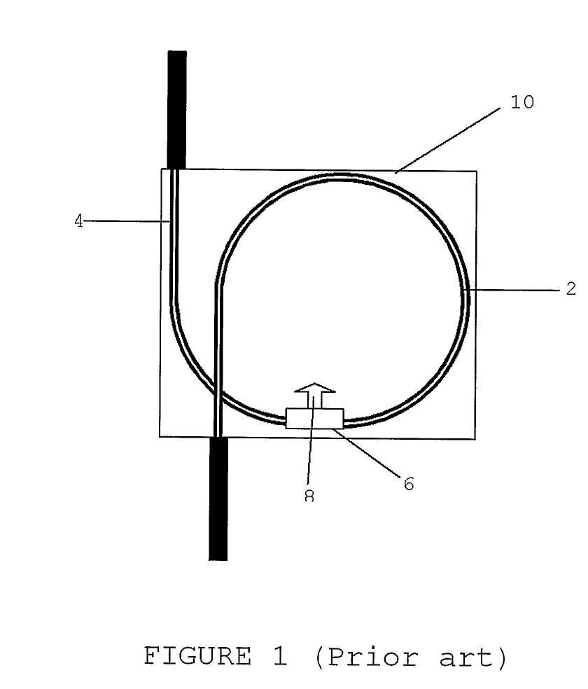

Currently, gas blocking at a connection of two tubes containing multiple optical fibres or fibre units is achieved in one method as illustrated in FIG. 1. A loop is formed in the external tube 2, which is then joined to the internal tube 4 by ‘T’ connector 6. Once the optical fibres or fibre units have been installed into the tubes, a sealing material such as resin is injected into ‘T’ connector 6 through nozzle 8 to form a seal around the individual optical fibres or fibre units. The loop in the tube is necessary to ensure that the connector is in the horizontal plane, to allow gravity to maintain the resin in place until it has cured. An individual ‘T’ connector is used for each tube, which may be one of many in a multi-tube cable. Once gas blocking has been completed, an enclosure 10 is placed around the tube loops and ‘T’ connectors.

One disadvantage of the current method is that the tubes must not be subjected to less than a particular bend radius, for example 50 mm, to prevent tube kink or tube collapse. A minimum bend radius must also be maintained for the purpose of installing optical fibres by the blown fibre technique. Therefore the resultant enclosure has to be large enough to house the loop of the tube, the minimum size of which is determined by the minimum bend radius of each tube. The enclosure must also be deep enough to house all the ‘T’ connectors, (i.e. one per tube for a multi-tube cable of, for example, nineteen tubes).

In the current method, nozzle 8 of ‘T’ connector 6 must be sealed, for example with a large plastic bung, to stop the flow of air from the blowing route when installing optical fibres by the blown fibre method. The enclosure must be of a sufficient size and shape to allow for manual insertion of resin and for positioning and removal of the bung.

The above method allows for gas blocking at a connection of two tubes for optical fibres. Methods are also known for gas blocking at a terminal end of tube without provision for connection to another tube. One such method is described in WO03/062890 (Tyco Electronics), in which a resilient sleeve is placed over a tube end such that optical fibres projecting beyond the end of the tube are contained within the sleeve. A tie is used to sealingly clamp part of the sleeve onto the optical fibres as they project from the tube end, and resin is then inserted into the sleeve beyond the tie, to form a seal around the optical fibres. Whilst the use of the clamping member prevents the flow of resin along the tube, the sleeve must be kept in a vertical orientation to allow gravity to maintain the resin in place until it has cured. This method is also restricted in its use, as the method relies on one end of the sleeve being free for the insertion of resin. Therefore the method could only be used at the end of a tube route, and not at a connection point for two tubes.

It is known from U.S. Pat. No. 4,640,978 (Kilbane et. al.), U.S. Pat. No. 2,711,438 (Bissell) and U.S. Pat. No. 2,402,840 (Olley) to insert a sealing material into a conduit carrying wires/conductors, and to provide packing material to prevent the flow of the sealing material beyond a required area. However, in these arrangements, the conduit must be maintained in a vertical orientation to allow for insertion of resin. Further, as the packing material in these arrangements does not exert a positive grip on the wires, only one level of gas blocking is provided, and movement of the wires longitudinally along the conduit (i.e. movement through the packing material/resin) is not prevented. Such movement could provide a gas leak, and therefore these arrangements are cannot provide an efficient gas seal.

There is a need for an connector which can provide an improved degree of gas blocking at the connection point of tubes containing multiple optical fibres or fibre units, wherein the connector and/or conduit does not have to be arranged or maintained in a particular orientation during insertion and curing of the resin.

Accordingly, the present invention provides a coupling for conduit tubes for carrying optical fibres comprising a body having a first and a second entry defined by a first and second entry means, both the first and second entries having associated therewith means to secure the body to conduit tubes inserted in the entries, the body further provided with a space between the first and second entries through which one or more optical fibres may pass, at least a third entry defined by a third entry means, arranged to enable insertion of sealing material into the space, and means to maintain the sealing material within the space.

In the present invention, one or more fibres may be contained within a unit, as defined previously.

The general construction of the coupling is such to provide an in-line connector for single or multiple optical fibres/fibre units which allows for installation of the optical fibres or fibre units by the blown fibre technique.

An advantage of the present invention is that there is no requirement for the coupling to be vertical for the curing of the resin. Therefore the coupling can be used in any orientation (provided the nozzle is arranged such that resin does not leak prior to curing), and the need to form a loop in the tube is eliminated.

As there is no requirement for a loop in the tube, the enclosure surrounding the tube couplings can be smaller and more cost effective. Positioning and removal of the bung for sealing the nozzle to enable installation by blown fibre technique, and insertion of resin are also simpler.

Reference will now be made to embodiments of the invention by way of example to the accompanying drawings.

FIG. 1 is a schematic representation of the prior art method for gas blocking at the connection point of tubes containing multiple optical fibres or fibre units.

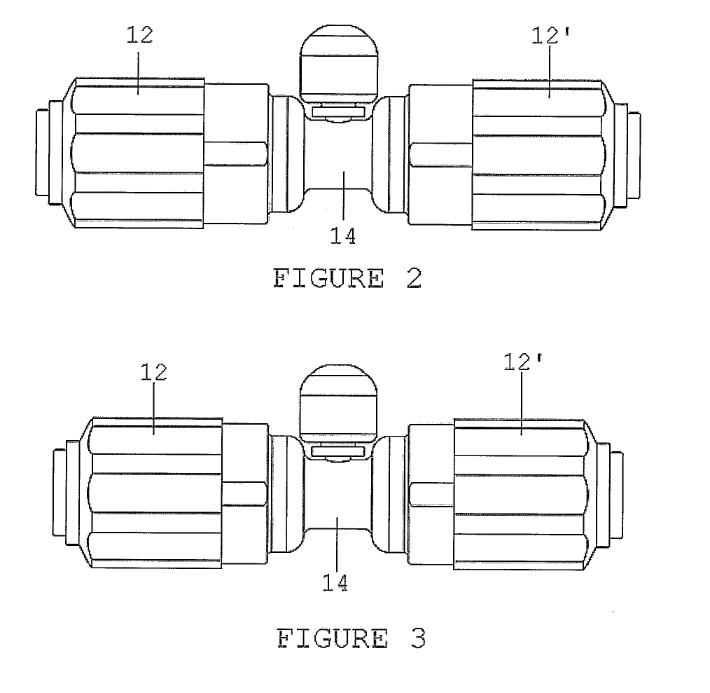

FIG. 2 is a side elevation of a tube coupling in accordance with the present invention in an ‘open’ position.

FIG. 3 is a side elevation of the tube coupling in a ‘closed’ position.

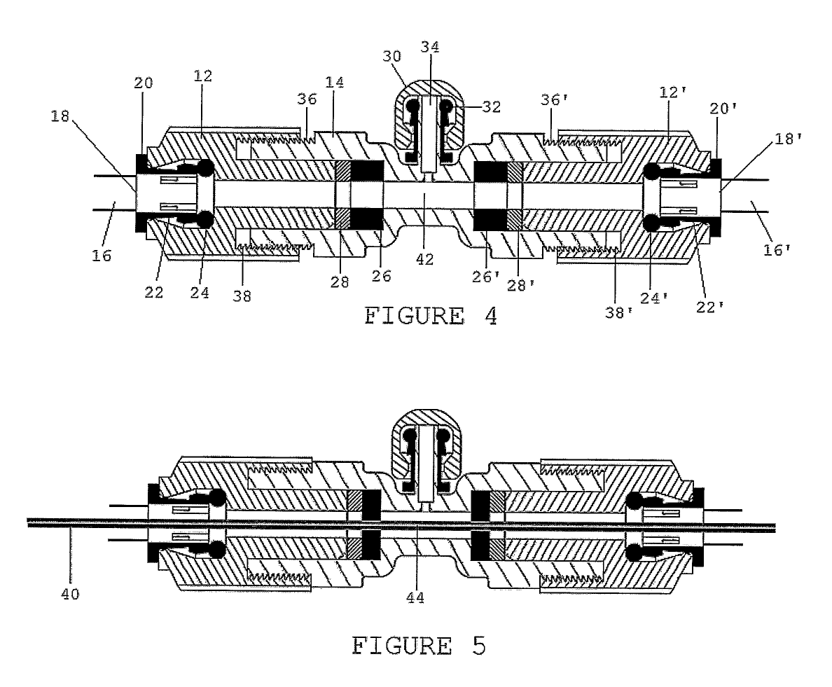

FIG. 4 is a longitudinal cross section of the tube coupling in an ‘open’ position.

FIG. 5 is a longitudinal cross section of the tube coupling in a ‘closed’ position.

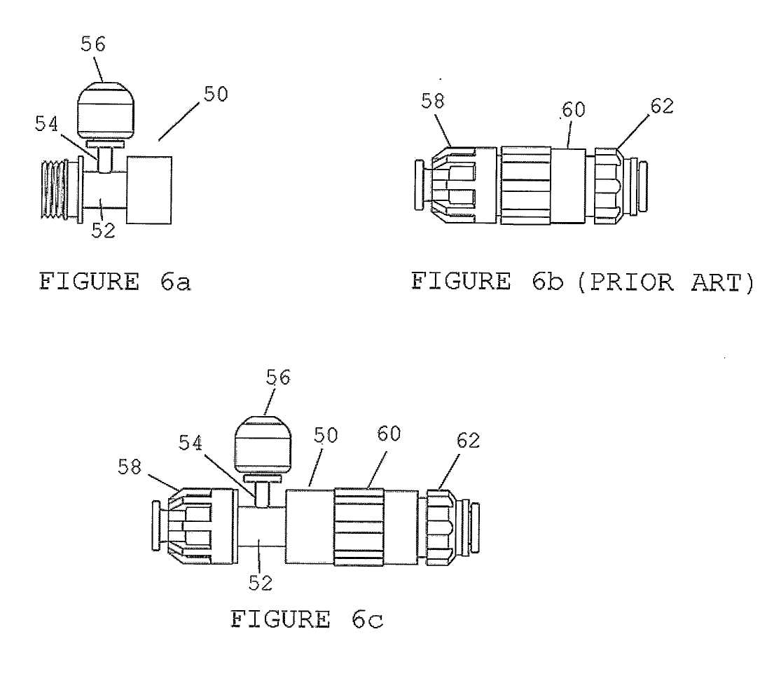

FIG. 6a is a side elevation of a ‘T’ adapter in accordance with the present invention.

FIG. 6b is a side elevation of a proprietary connector for a single optical fibre/single fibre unit.

FIG. 6c is a side elevation of the connector of FIG. 6b being used in conjunction with the ‘T’ adapter of FIG. 6a.

As illustrated in FIGS. 2 and 3, the tube coupling in one embodiment comprises a first body section 12 and a second body section 12′, linked by a ‘T’ section 14. FIG. 2 shows the tube coupling in an ‘open’ position, allowing optical fibres or fibre units to be installed by the blown fibre method. After installation, the tube coupling is moved to the ‘closed’ position of FIG. 3 to allow for insertion of resin for gas blocking.

Referring to FIG. 4, a first tube 16 and a second tube 16′ are inserted into tube entries 18 and 18′ provided in first body section 12 and second body section 12′ respectively. Tubes 16 and 16′ are held in place by resilient arms 22 and 22′ of collets 20 and 20′. ‘O’ rings 24 and 24′ are provided between each collet and body section.

Compression seals 26 and 26′ and compression seal washers 28 and 28′ are provided between ‘T’ section 14 and first body section 12 and between ‘T’ section 14 and second body section 12′. For installation of optical fibres or fibre units, compression seals 26 and 26′ must be in an open position, as illustrated in FIGS. 2 and 4, to allow optical fibres or fibre units to pass through the tube coupling.

A nozzle 34 is provided in ‘T’ section 14. Nozzle 34 is provided with an end stop 30 and seals 32 to prevent the escape of air during installation of optical fibres or fibre units by the blown fibre method.

Collets 20 and 20′, ‘O’ rings 24 and 24′, and end stop seals 32 provide sufficiently tight seals against blown fibre technique installation pressures of, e.g. 12 bar, and burst pressures of for example installation pressure multiplied by 2.5.

Once the optical fibres or fibre units have been installed, body sections 12 and 12′ are screwed fully onto ‘T’ section 14 via external threads 36 and 36′ provided on ‘T’ section 14 and associated internal threads 38 and 38′ provided on body sections 12 and 12′, causing compression seals 26 and 26′ to close around optical fibres or fibre units 40 as illustrated in FIG. 5.

Resin is injected through nozzle 34 into a resin chamber 42 provided in ‘T’ section 14, with compression seals 26 and 26′ creating a restriction past which the resin cannot proceed. The optical fibre or fibre unit interstices 44 as illustrated in FIG. 5 allow for the expulsion of air from the resin chamber as the resin is injected through nozzle 34.

As the resin cannot flow past the restriction provided by the compression seals 26 and 26′, there is no requirement to form a loop in either of the tubes to be connected to ensure the coupling is vertical, therefore the coupling can be used in any plane.

The ‘T’ section 14 may be manufactured from an essentially clear plastics material. This would enable visual inspection of the fill level of the resin as it is inserted to allow the correct level to be easily achieved.

The ‘T’ section 14 of the present invention could be designed to be used with a proprietary single optical fibre/single fibre unit connector. FIG. 6a shows a ‘T’ adapter 50 suitable for use with the proprietary connector of FIG. 6b. The ‘T’ adapter comprises a chamber 52, nozzle 54, and end stop 56 to seal nozzle 54 for installation of fibres by the blown fibre technique.

FIG. 6c illustrates ‘T’ adapter 50 positioned between screw cap 58 and main connector body 60 of the proprietary connector of FIG. 6b. In normal use of the connector, an internal seal (not shown) is activated by turning internal seal adjustment 62 to provide a mechanical seal around the single optical fibre or single fibre unit. When used in conjunction with ‘T’ adapter 50, the internal seal can be used to provide a restriction past which resin, (inserted through nozzle 54), cannot proceed. Therefore ‘T’ adapter 50 allows for resin gas blocking, thus allowing the connector to be used with multiple optical fibres or multiple fibre units. However, as only one internal seal is provided in this configuration, the assembly works most efficiently in the vertical plane.

The ‘T’ adapter could also be used to provide a further level of gas blocking for tubes containing a single optical fibre or a single fibre unit than is provided by current proprietary gas blocking connectors with integral sealing.

1. A blown fibre conduit tube coupling for carrying optical fibres comprising a body having a first and a second entry defined by a first and second entry means, both the first and second entries having associated therewith means to secure the body to conduit tubes inserted in the entries, the body further provided with a space between the first and second entries through which one or more optical fibres may pass, at least a third entry defined by a third entry means, arranged to enable insertion of sealing material into the space, and means to maintain the sealing material within the space wherein the means to maintain the sealing material within the space comprises at least one seal which is deformable from a relaxed state to a compressed state wherein the internal diameter of the seal in the compressed is less than the internal diameter in the relaxed state.

2. A coupling as claimed in claim 1 wherein the space is defined by a chamber consisting at least partially of a plastics material, the plastics material being at least partially transparent.

3. A coupling for conduit tubes for carrying optical fibres as claimed in claim 1 wherein at least one means to secure the body to conduit tubes comprises a collet with resilient arms.

4. A coupling as claimed in any claims 1, 2, or 3 wherein seals are provided to seal the body against the conduit tubes.

5. A coupling as claimed in any claims 1, 2, or 3 wherein the third entry comprises a nozzle with a removable end stop and means are provided to seal the end stop against the nozzle.

6. A blown fibre conduit tube coupling adaptor for carrying optical fibres comprising an adaptor body having a first and a second entry, both the first and second entries adapted to receive means to secure the body to conduit tubes inserted in the entries, the body further provided with a space between the first and second entries through which one or more optical fibres may pass, at least a third entry defined by a third entry means, arranged to enable insertion of sealing material into the space, and means to maintain the sealing material within the space wherein the means to maintain the sealing material within the space comprises at least one seal which is deformable from a relaxed state to a compressed state wherein the internal diameter of the seal in the compressed is less than the internal diameter in the relaxed state.

7. The coupling as claimed in claim 6 wherein the third entry means comprises a nozzle with a removable end stop and means are provided to seal the end stop against the nozzle.

8. A blown fibre conduit tube coupling for carrying optical fibres comprising:
a body adapted for attachment to optical fibre conduit tubes and defining a chamber adapted for blowing optical fibre therethrough between the conduit tubes;
at least one deformable seal associated with the chamber, adapted for adjustment between a first position for blowing optical fibre through the chamber and a second position substantially sealing between optical fibre portions and chamber wall portions; and
an opening through the body into the chamber adapted for insertion of sealing material into the chamber.

9. The coupling of claim 8 wherein the first position of the seal is relaxed, the second position of the seal is compressed, and a seal internal diameter is less in the compressed position than in the relaxed position.

10. A method for sealing optical fibre conduit tubes, comprising:
attaching a coupling with at least one deformable seal between optical fibre conduit tubes;
blowing optical fibre through the tubes, coupling and seal;
deforming the at least one seal associated with the coupling to seal between portions of the optical fibre and portions of the coupling; and
inserting sealing material around the optical fibre within the coupling.

11. The method of claim 10 wherein the deforming includes compressing the seal from a relaxed position with a first internal diameter to a compressed position with a smaller second internal diameter.

12. The method of claim 10 wherein attaching a coupling between optical fibre conduit tubes includes attaching using a collet with resilient arms.

13. The method of claim 10 wherein inserting sealing material around the optical fibre includes inserting sealing material into an at least partially transparent portion of the coupling.

14. The method of claim 10 wherein inserting sealing material includes inserting sealing material through a nozzle having a removable end stop.

15. The method of claim 10 wherein attaching a coupling between optical fibre conduit tubes includes sealing the coupling to the conduit tubes.
